(19) United States
(12) Patent Application Publication
(10) Pub. No.: US 2011/0023704 A1
(43) Pub. Date: Feb. 3, 2011

(54) PUMP, IN PARTICULAR HIGH-PRESSURE FUEL PUMP

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/934,416

(22) PCT Filed: Feb. 2, 2009
(86) PCT No.: PCT/EP2009/051112

§ 371 Date: Sep. 24, 2010

(30) Foreign Application Priority Data
Mar. 26, 2008 (DE) 102008000824.9

(51) Int. Cl. F16J 1/10

(52) U.S. Cl. 92/129

(57) ABSTRACT

The invention relates to a pump, having at least one pump element, which has a pump piston driven in a lifting motion at least indirectly by a drive shaft. The pump piston is guided in a cylinder bore of a housing part of the pump, and the housing part has a cylindrical section surrounding the cylinder bore. A cup-shaped tappet is disposed between the pump piston and the drive shaft and has a bottom facing the drive shaft. A jacket of the tappet is guided on the cylindrical section of the housing part in a displaceable manner. A spring is provided, by means of which the tappet is pressurized toward the drive shaft. The pump piston abuts the bottom of the tappet with the front thereof facing the drive shaft. A disk is mounted on the pump piston in the end region thereof facing the base of the tappet has a greater outside diameter than the pump piston. The pump piston has the disk is secured in the tappet in the direction of the longitudinal axis of the pump piston by means of a safety element engaging in the disk.

### PRIOR ART

The invention is based on a pump, in particular a high-pressure fuel pump, as generically defined by the preamble to claim 1.

One such pump in the form of a high-pressure fuel pump is known from German Patent Disclosure 10 2004 013 246 A1. This pump has at least one pump element, having a pump piston that is driven in a reciprocating motion at least indirectly by a drive shaft. The pump piston is guided displaceably in a cylinder bore of a housing part of the pump, and the housing part has a cylindrical portion surrounding the cylinder bore. Disposed between the pump piston and the drive shaft is a cuplike tappet, which is guided displaceably with its jacket on the cylindrical portion of the housing part. The tappet furthermore has a floor pointing toward the drive shaft. A spring engaging the tappet and urging it toward the drive shaft is provided. With its face end oriented toward the drive shaft, the pump piston rests on the bottom of the tappet. The pump piston and the tappet, in this pump, are separate components that are not connected to one another. For this reason, installing the pump piston and the tappet in the pump is complicated, since these parts are all present in separate form and can be joined together only in the pump.

### DISCLOSURE OF THE INVENTION

### Advantages of the Invention

The pump according to the invention having the characteristics of claim 1 has the advantage over the prior art that the pump piston and the tappet can already be joined together as a unit before being installed in the pump, thus facilitating their installation in the pump.

In the dependent claims, advantageous features and refinements of the pump of the invention are disclosed. By the embodiment according to claim 4, the pump piston can be produced in an especially simple way. With the characteristic of claim 5, simple fastening of the disk on the pump piston is made possible. In claim 7, a simply embodied securing element is disclosed.

### DRAWINGS

One exemplary embodiment of the invention is shown in the drawings and described in further detail in the ensuing description. FIG. 1 shows a pump in a longitudinal section, and

FIG. 2, in an enlarged view, shows a detail of the pump in cross section taken along the line II-II in FIG. 1.

### DESCRIPTION OF THE EXEMPLARY EMBODIMENT

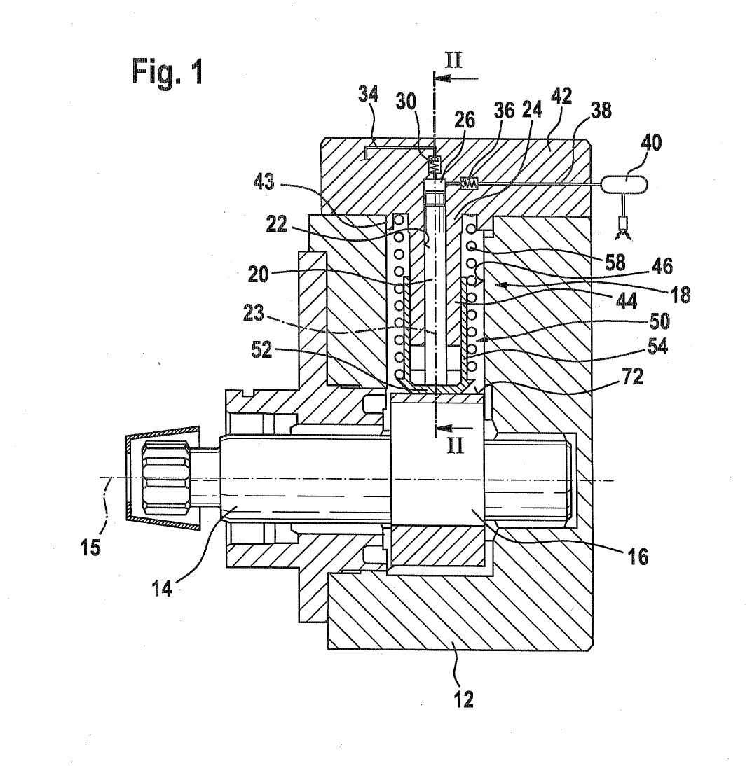

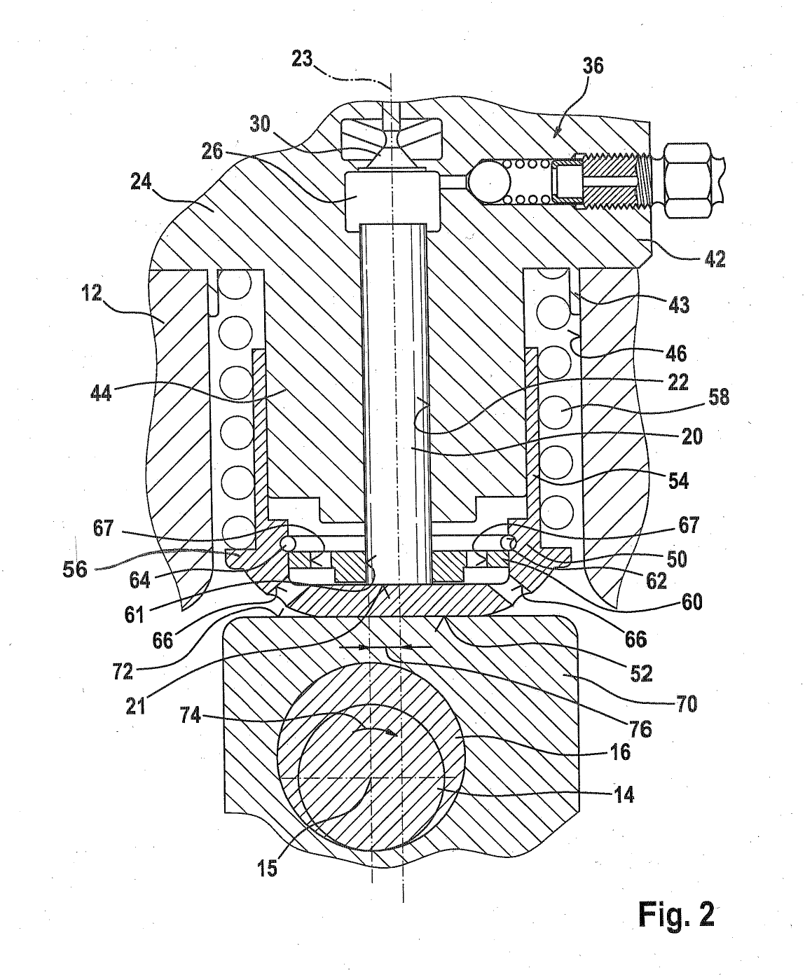

In FIGS. 1 and 2, a pump is shown which in particular is a high-pressure fuel pump for a fuel injection system of an internal combustion engine. The pump has a housing 10, which may be embodied in multiple parts and in which a rotationally driven drive shaft 14 is supported rotatably about an axis of rotation 15. The drive shaft 14 has at least one eccentric element 16, which is embodied eccentrically to the axis of rotation 15 of the drive shaft 14. Alternatively, instead of the eccentric element 16, the drive shaft 14 may have at least one cam. The pump has at least one or more pump elements 18, each with a pump piston 20 which is driven at least indirectly in a reciprocating motion, in a direction at least approximately radial to the axis of rotation 15 of the drive shaft 14, by the eccentric element 16 or cam of the drive shaft 14. It may also be provided that the pump does not have its own drive shaft 14, and instead, the pump piston 20 of the pump element 16 is driven by a shaft of the engine, which has an eccentric element 16 or cam.

The pump piston 20 is guided tightly in a cylinder bore 22 of a housing part 24 of the pump. With its end remote from the drive shaft 14, the pump piston 20 defines a pump work chamber 26 in the cylinder bore 22. Via an inlet check valve 30 opening into it, the pump work chamber 26 has a communication with an inlet 34, originating at a feed pump 32, by way of which inlet the pump work chamber 26 is filled with fuel, in the suction stroke of the pump piston 20 that is oriented radially inward toward the axis of rotation 15 of the drive shaft 14. Also, via an outlet check valve 36 opening out of it, the pump work chamber 26 is in communication with an outlet 38, which leads for instance to a high-pressure fuel reservoir 40 and by way of which fuel is positively displaced out of the pump work chamber 26 in the delivery stroke, oriented radially outward, away from the axis of rotation 15 of the drive shaft 14, of the pump piston 20.

The housing part 24 has a flangelike region 42, which rests on the housing part 12, and a cylindrical portion 44 protruding from the region 42. Beginning at the face end of the portion 44, the cylinder bore 22 extends through the portion 44 into the region 42 where the pump work chamber 26 is disposed. The inlet valve 30 and the outlet valve 36 are also disposed in the region 42. At the transition from the region 42 to the portion 44, a centering collar 43 of greater diameter than the portion 44 is provided, which enters with little play into a bore 46 in the housing 12 and ensures centering of the housing part 24 with respect to the housing 12.

A cuplike tappet 50 is disposed between the pump piston 20 and the eccentric element 16 or cam of the drive shaft 14. The tappet 50 has a bottom 52, oriented toward the drive shaft 14, and a jacket 54, adjoining it in the direction away from the drive shaft 14; the bottom 52 and the jacket 54 may be embodied in one piece or as separate components that are joined to one another. The jacket 54 of the tappet 50 is guided displaceably with little play on the cylindrical portion 44 of the housing part 24. The longitudinal axis of the tappet 50 is at least approximately identical to the longitudinal axis 23 of the cylinder bore 22 and to the longitudinal axis of the pump piston 20. From the jacket 54 of the tappet, near the bottom 52, an annular collar 56 protrudes outward, between which and the flange 42 of the housing part 24 a prestressed spring 58, which is preferably a helical compression spring, is fastened.

Over its entire length, the pump piston 20 has a constant diameter, and with its end oriented toward the drive shaft 14 it protrudes out of the cylinder bore 22. Near the end of the pump piston 20 that protrudes out of the cylinder bore 22, a disk 60 of greater outside diameter than the pump piston 20 is fastened on the pump piston. The disk 60 is preferably press-fitted onto the pump piston 20. The disk 60 may, as shown in FIG. 2, have a greater thickness in its radially inner region resting on the pump piston 20 than in its radially outer region, and as a result a step is formed on the disk 60 toward the bottom 52 of the tappet 50. The end of the pump piston 20 protrudes outward in the direction of the longitudinal axis 23 somewhat past the disk 60, so that the face end 21 of the pump piston 20 rests on the bottom 52, while the disk 60 is disposed with a slight spacing from the bottom 52.

The outside diameter of the disk 60 is somewhat less than the inside diameter of the jacket 54 of the tappet 50, in the region in which the disk 60 is disposed inside the jacket 54. It may be provided that in the region in which the disk 60 is disposed, the inside diameter of the jacket 54 is somewhat less than in the region of the jacket 54 that is guided on the cylindrical portion 44. As a result, in the vicinity of the disk 60, the jacket 54 has a greater wall thickness than in its region guided on the portion 44. In the inside circumference of the jacket 54 of the tappet 50, an encompassing annular groove 62 is made, into which a securing element 64 is inserted that fits radially inward over the disk 60, on its side facing away from the bottom 52 of the tappet 50. The securing element 64 is preferably embodied as an elastic spring ring, which because it is prestressed radially outward is latched in the annular groove 62. By means of the securing element 64 and the disk 60, the pump piston 20 is secured in the tappet 50 in the direction of the longitudinal axis 23; thus the pump piston 20, with the disk 60, and the tappet 50 are connected to one another in the direction of the longitudinal axis 23, but a limited relative motion between the tappet 50 and the pump piston 20 perpendicular to the longitudinal axis 23 is possible. The tappet 50 has at least one and preferably a plurality of openings 66, and the disk 60, in its region between the pump piston 20 and the jacket 54 of the tappet 50, has at least one and preferably a plurality of openings 67. By means of the openings 66, 67, the space defined between the tappet 50 and the portion 44 of the housing part 24 communicates with this surrounding region, so that a pressure equilibrium in this space upon the reciprocating motion of the pump piston 20 is ensured.

A ring 70 on which the tappet 50 rests with its bottom 52 can be rotatably supported on the eccentric element 16 of the drive shaft 14. The ring 70, in the region where the bottom 52 of the tappet 50 rests, has a flattened face 72, and the bottom 52 of the tappet 50 is likewise embodied as at least approximately plane, resulting in a two-dimensional contact between the bottom 52 and the ring 70. It may be provided that viewed in cross section in FIG. 2, the longitudinal axis 23 of the pump piston 20 has a course offset by a spacing 76 from the axis of rotation 15 of the drive shaft 14 in the direction of rotation 74 of the drive shaft 14, so that the longitudinal axis 23 does not intersect the axis of rotation 15.

In the assembly of the pump, the disk 60 can be secured to the pump piston 20, and in particular press-fitted onto it, outside the housing 12; next, the pump piston 20, with the disk 60, is inserted into the tappet 50, and the securing element 64 is fitted in. The spring 58 can then be mounted on the combination comprising the pump piston 20 and the tappet 50, and this structural unit can then be installed on the housing part 24, by introducing the pump piston 20 into the cylinder bore 22 and thrusting the jacket 54 of the tappet 50 onto the portion 44. The housing part 24 with the pump piston 20 and tappet 50 can then be inserted into the housing 12.

1-8. (canceled)

9. A pump, in particular a high-pressure fuel pump, having at least one pump element which has a pump piston that is driven in a reciprocating motion at least indirectly by a drive shaft, the pump piston being guided in a cylinder bore of a housing part of the pump, the housing part having a cylindrical portion surrounding the cylinder bore, and between the pump piston and the drive shaft, a cuplike tappet is disposed which has a bottom, oriented toward the drive shaft, and which has a jacket adjoining the bottom, the jacket of the tappet being guided displaceably on the cylindrical portion of the housing part, a spring being provided, by which the tappet is urged toward the drive shaft, the pump piston having a face end oriented toward the drive shaft, rests on the bottom of the tappet, and a disk being provided which has a larger outside diameter than the pump piston and which is fastened on the pump piston in an end region of the pump piston oriented toward the bottom of the tappet, wherein the pump piston has the disk secured in the tappet in a direction of a longitudinal axis of the pump piston by means of a securing element engaging the disk.

10. The pump as defined by claim 9, wherein the pump piston, with its face end resting on the bottom of the tappet, protrudes in a direction Of the longitudinal axis of the pump piston past the disk.

11. The pump as defined by claim 9, wherein the pump piston with the disk is movable perpendicular to the longitudinal axis of the pump piston to a limited extent.

12. The pump as defined by claim 10, wherein the pump piston with the disk is movable perpendicular to the longitudinal axis of the pump piston to a limited extent.

13. The pump as defined by claim 9, wherein the pump piston, over an entire length thereof, has an at least essentially constant diameter.

14. The pump as defined by claim 10, wherein the pump piston, over an entire length thereof, has an at least essentially constant diameter.

15. The pump as defined by claim 11, wherein the pump piston, over an entire length thereof, has an at least essentially constant diameter.

16. The pump as defined by claim 12, wherein the pump piston, over an entire length thereof, has an at least essentially constant diameter.

17. The pump as defined by claim 9, wherein the disk is press-fitted onto the pump piston.

18. The pump as defined by claim 10, wherein the disk is press-fitted onto the pump piston.

19. The pump as defined by claim 11, wherein the disk is press-fitted onto the pump piston.

20. The pump as defined by claim 13, wherein the disk is press-fitted onto the pump piston.

21. The pump as defined by claim 9, wherein the disk has at least one opening in a region of the disk between the pump piston and the jacket of the tappet.

22. The pump as defined by claim 10, wherein the disk has at least one opening in a region of the disk between the pump piston and the jacket of the tappet.

23. The pump as defined by claim 16, wherein the disk has at least one opening in a region of the disk between the pump piston and the jacket of the tappet.

24. The pump as defined by claim 20, wherein the disk has at least one opening in a region of the disk between the pump piston and the jacket of the tappet.

25. The pump as defined by claim 9, wherein the securing element is a spring ring, which is latched radially outward into an annular groove in an inside circumference of the jacket and which fits radially inward over the disk, on a side of the disk remote from the bottom of the tappet.

26. The pump as defined by claim 24, wherein the securing element is a spring ring, which is latched radially outward into an annular groove in an inside circumference of the jacket and which fits radially inward over the disk, on a side of the disk remote from the bottom of the tappet.

27. The pump as defined by claim 9, wherein the jacket of the tappet, in the vicinity of the disk, has a lesser inside diameter and a greater wall thickness than in its region guided on the cylindrical portion of the housing part.

28. The pump as defined by claim 26, wherein the jacket of the tappet, in the vicinity of the disk, has a lesser inside diameter and a greater wall thickness than in its region guided on the cylindrical portion of the housing part.
